(19) United States
(12) Patent Application Publication
(10) Pub. No.: US 2012/0198375 A1
(43) Pub. Date: Aug. 2, 2012

(54) MULTI-CONDITION RESOURCE PLANNING

(76) Inventors: Stephen R. Carter, Spanish Fork, UT (US); Jonathan Paul Bultmeyer, Dorchester, MA (US); Gregory Matthew Haskins, Worcester, MA (US)

(21) Appl. No.: 13/015,313

(22) Filed: Jan. 27, 2011

(51) Int. Cl. G06F 9/46; G06F 3/048

(52) U.S. Cl. 715/771; 718/102

(57) ABSTRACT

Techniques for multi-condition resource planning are presented. A principal interactively establishes a resource plan for a workflow by making selections for the workflow. Impacts that are forecasted based on the selections are dynamically presented to the principal and the principal is permitted to make adjustments. The finalized resource plan results in the workflow that is subsequently processed according to policy.

### BACKGROUND

Cloud computing is rapidly changing the Internet into a collection of clouds, which provide a variety of computing resources, storage resources, and, in the future, a variety of resources that are currently unimagined. This new level of virtualization has unbounded or should have unbounded the physical and geographical limitations of traditional computing.

Resource planning by an Information Technology (IT) shop and enterprises (utilizing a data center, private cloud, and public cloud) is going to become very challenging and problematic. The wealth of resources available to an IT administrator makes it more and more difficult to adequately plan for utilization of resources, such that the goals of the enterprise can be met. This especially becomes problematic when one realizes that in a private cloud different resources within the cloud may be owned and operated by different departments or business units within the enterprise. In cases such as these, the different departments and/or business units may implement a charge-back scheme where other departments and/or business units of the enterprise may utilize their resources but at a cost and/or credit accumulation scheme. The task of sorting out all of the different cost metrics, resource availability metrics, ownership and availability issues, etc. becomes a daunting exercise.

Consequently, better planning, forecasting and managing of resources are needed in order to account for the diverse situations and environments that are encountered by enterprises.

### SUMMARY

Techniques for multi-condition resource planning are presented. More particularly, and in an embodiment, a method for multi-condition resource planning and management is described.

Specifically, a request is received for creating a resource plan from a principal; the resource plan for a workflow using multiple resources. Next, a time and date selection for when the workflow is to be processed is acquired from the principal. The principal is interacted with to obtain resource identifiers for the multiple resources and restrictions to be enforced on each resource before and during use with the workflow. Then, one or more impacts are dynamically presented to the principal. The one or more impacts are associated with the time and date selection and usage of the multiple resources having the restrictions. The principal is then permitted to make adjustments to the time and date selection, the multiple resources, and the restrictions based on the impacts. Finally, and the resource plan for the workflow is finalized with the principal. The resource plan having the resource identifiers, the restrictions and the workflow to be processed at the time and date selection.

### BRIEF DESCRIPTION OF THE DRAWINGS

FIG. 1 is a diagram depicting components and the interactions of those components for a multi-condition resource planning and managing system, according to an example embodiment.

FIG. 2 is a diagram of a method for multi-condition resource planning and management, according to an example embodiment.

FIG. 3 is a diagram of another method for multi-condition resource planning and management, according to an example embodiment.

FIG. 4 is a diagram of a multi-condition resource planning and managing system, according to an example embodiment.

### DETAILED DESCRIPTION

A “resource” includes a user, service, system, device, directory, data store, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

A “workload” as used herein refers to a special type of resource, such as a Virtual Machine (VM), an Operating System (OS), a cloud, a hardware device, an agent, and/or an application.

An “identity” is something that is formulated from one or more identifiers and secrets that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc.

Various embodiments of this invention can be implemented in existing network architectures. For example, in some embodiments, the techniques presented herein are implemented in whole or in part in the Novell® operating system products, directory-based products, cloud-computing-based products, and other products distributed by Novell®, Inc., of Waltham, Mass.

Also, the techniques presented herein are implemented in machines, such as processor or processor-enabled devices. These machines are configured to specifically perform the processing of the methods and systems presented herein. Moreover, the methods and systems are implemented, programmed, and reside within a non-transitory computer-readable storage media or machine-readable storage medium and are processed on the machines configured to perform the methods.

Of course, the embodiments of the invention can be implemented in a variety of architectural platforms, devices, operating and server systems, and/or applications. Any particular architectural layout or implementation presented herein is provided for purposes of illustration and comprehension only and is not intended to limit aspects of the invention.

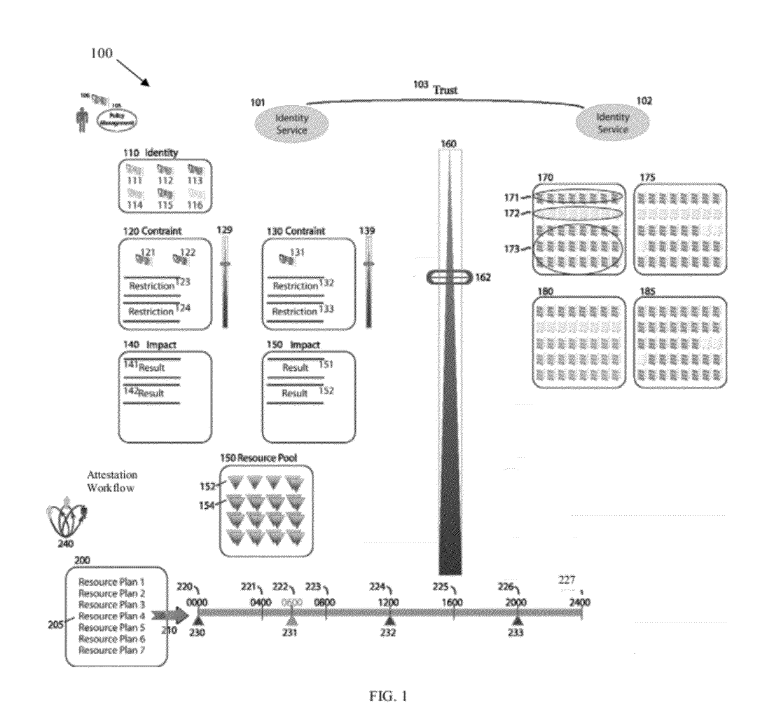

It is within this context that embodiments of the invention are now discussed within the context of FIGS. 1-4.

FIG. 1 is a diagram depicting components and the interactions of those components for a multi-condition resource planning and managing system. The components of the FIG. 1 are implemented in a machine-accessible and non-transitory computer-readable medium as instructions that execute on one or more processors (machines, computers, processors, etc.). The machines are specifically configured and programmed to process each of the components. Furthermore, the components are operational over and processes within one or more networks. The network(s) may be wired, wireless, or a combination of wired and wireless.

Various embodiments of the techniques proposed herein and below utilize an Identity Service. For example, Identity Services 101 and 102 can be used along with an associated Trust Specification 103. While just two Identity Services (101 and 102) and one Trust Specification 103 are shown, it is to be understood that some “n” Identity Services can be connected by some “m” Trust Specifications in such a way as to produce a web of Identity Services connected by Trust Specifications that produce mechanisms for an identity created, at 101, to be trusted in some manner, at 102 for example. There may also be Identity Services that are not connected via Trust Specification 103, which thusly have no specific Trust Specification to govern a trust of identity between the two Identity Services (101 and 102).

The approaches and mechanisms discussed herein utilize an Identity Service at 101 and 102 along with an associated Trust specification at 103. While only two Identity Services and one Trust is shown it is to be understood that any “n” Identity Services can be connected by some “m” Trusts, in such a way as to produce a web of Identity Services connected by Trust that may produce ways and means for an identity created at, say, 101 to be trusted in some manner at, say, 102 for example. There may also be Identity Services that are not connected, via Trust 103, which would have no specific trust specification to govern a trust of identity between the two Identity Services.

Therefore, techniques discussed herein and below utilize several (two shown in FIG. 1) Identity Services (101 and 102) that have a Trust (103) so that the identities (e.g., 110, 111, 112, 113, 114, 115, 116, 160, 220) may be used in a manner wherein the specifications within the identities can be trusted in some manner (e.g., roles specified by 101 can map to roles in 102 which are individually governed by policy).

The techniques herein provide for a user/agent to utilize an IT Admin 105 process after obtaining an identity 106 that specifies the rights, permissions, roles, etc. that the IT Admin 105 is allowed to act within.

The techniques herein also provide for an IT administrator at 105 that utilizes an identity at 106 to develop resource plans at 200, such that each resource plan is effective over some time span and may change during that time span.

For example, Resource Plan 4, at 205, has a timeline indicated at 210 which has several time marks on it at 220, 221, 222, 223, 224, 225, 226, and 227. The markers at the bottom of the timeline, at 230, 231, 232, and 233 represent markers where the resource plan changes in some way. The resource marker, at 231, is a different shade of grey because that is the resource marker that the IT administrator is currently affecting. Therefore, each affected location on the timeline, such as 231 within a resource plan (such as Resource Plan 4 at 205) has an associated resource plan, which is depicted above the timeline in FIG. 1.

It is also well to note that each resource plan affects the operational characteristics of an enterprise. Because of this, it may be required that a workflow be enabled to approve such a resource plan for utilization in the enterprise. This is depicted by 240 where in an attestation workflow is enabled for each resource plan so that the appropriate personnel within the enterprise can attest to the accuracy and validity of the resource plan. This is done by the acquisition of identities by each attester so that the resource plan can be attested to (e.g., digitally signed) before utilization within the enterprise.

The techniques herein provide for a Resource Pool, at 150, such that individual workloads, shown at 152, and multiple workloads, shown at 154 (also known as a TesselApp), are provided for the IT administrator to plan resources, such that the workloads can be executed. The workloads and 150 have been predefined and attested to via mechanisms that are not a part of this invention.

The IT administrator, at 105, has available a series of identities, at 110, such as: 111, 112, 113, 114, 115, and 116 where each identity has been provided by an identity service such as 101 and 102 so that rights, permissions, and or roles are specified in a manner that can be verified and validated and therefore used as constraints elsewhere in the invention.

A resource plan begins by selecting an appropriate time on the timeline where the resource plan should be enacted and a previous resource plan terminated, such that constraints are declared at 120 and 130.

A constraint, such as at 120, can be built up by declaring valid identities, such as 121 and 122, which provide the constraint mechanism with the rights, permissions, privileges, and/or roles that the constraint is allowed to act within. In other words, identities associated with a constraint, such as 120 serves to provide constraint specifications. The constraint at 120 may also be augmented by restrictions such as at 123 and at 124 where the restriction is a collection of prioritized statement that specify how resources are to be selected in order to fulfill the resource plan.

The techniques herein also provide for a collection of resources such as: at 170, 175, 180, and 185 where resources are available to the IT administrator for the resource plan. For example, at 170, there is a collection of resources, at 171, which are in use during the time period and calendar that the current resource plan is being specified for (this is indicated by the deeper shade of grey in the FIG. 1) and resources, at 172, which belonged to the department that has been identified in the constraint (either via identity or restriction). Also other resources are shown, at 173, which are either not available for the resource plan or available at some cost. The different shades of grey for 175, 180, and 185 can also indicate to the IT administrator different availabilities, such that some show other departmental owned resources (whether in use or not) resources available from other departments or business units, resources currently in use by other departments or business units, which belonged to the department or business unit currently identified under the constraint, or resources that are available in a public clouds that are only available at some cost.

The distinction that some resources are available to the planner but are being used by other departments and/or business units is of import because the department and or business unit that owns those resources may be accruing either revenue or credits, which the IT administrator knows is important to that department and/or business unit. In this case, it may be important in the restrictions to prioritize at a very high level the stipulation or restriction that such resources not be used until the very end of the selection of resources as per the constraint specification.

In an embodiment, a slider is available to help the administrator resources according to the constraints and their priorities, which results in an impact analysis, at 140 and at 150; so that the resource planner understands the type of impact that is being accrued. Impact results may be in the form of total cost to the department and or business unit, loss of revenue and or credits because of the utilization of resources that are currently being used by paying customers, etc. Note that the impact of constraint 120 is displayed by the impact of 140 and the constraint at 130, which have impacted the display at 150.

In an embodiment the slider affects all of the constraints such as that shown at 160 where the slider reticule, at 162, is moved up and down showing how many resources are being used and how many resources from the resource pool are being enabled because of the position on the slider. For example, a group of 152 and 154 may have been specified by the resource planner, such that some number of users can be supported in an e-mail system, for example. By sliding 162 up-and-down the number of users changes because the number of resources, at 152 and at 154, which can be executed change because of the availability of resources from 170, 175, 180, and 185.

In an embodiment the sliders are associated with each constraint, such as 129 associated with 120 and 139 associated with 130. In this embodiment, the individual sliders are manipulated, which then change the resource allocation from 170, 175, etc. resource pools, as per the individual constraint that the slider is associated with. This is in contrast to a single slider, at 160, which manipulates both constraints (note that though the FIG. 1 shows two constraints there may be many constraints) where the single slider is manipulating the acquisition of resources from 170, 175, etc. as the priority is specified in the constraints at 120 and at 130.

To understand how a constraint works together with identities and restrictions an example is provided. The resource planner creates a resource plan, at 205, and selects a location on the timeline, such as 231 and then resource pool, at 150, depicts those resources that are to be run as a result of the resource plan. Such a collection of resources may be, for example, a website, a collection of reverse proxies, and e-mail system utilized by outgoing mail processes, etc. The resource planner then selects the identities that are going to be associated with each constraint, such as at 120 and 130 and then specifies the restriction, such as at 123 and 124 in priority order specifying what type of restrictions are to be applied during the acquisition of resources at 170, 175, etc. As the slider is utilized, at 160 and/or at 129 and at 139, indications in 170, 175, 180, and 185 are made to show what resources are allocated according to the priorities in the constraints along with the associated impacts, at 140 at 150, showing the various impacts to the department and or business unit as a result of the constraints and slider position. The impact, at 140 150, may be tabular or graphical or some combination depending on what best communicates the impact situation to the resource planner. Once a resource plan is established for 231, resource planner may move to 232 and repeat the exercise, possibly utilizing the plan from 231 or from elsewhere as a template to begin work on. At the end of defining Resource Plans, at 205, the workflow is enacted, which allows attestation, at 240, to be acquired so that the resource plan can be utilized in the enterprise according to some approval policy.

It is well to note that the invention provides for the display of resources at 170, 175, etc. as per the time on the timeline and the calendar date or day of week that the current resource plan is been specified for. This is because those resources may be being controlled by other resource plans and resources utilized or freed according to other resource plans. This again makes the impact analysis, at 140 and 150, significant.

Again (albeit only 2 constraints are shown at 120 and 130; 1 collection of identities at 110; 4 collections of processing resources at 170, 175, 180, 185; and 1 collection of executable resources at 150 for purposes of illustration), the actual number of each of the collections may be more or less than is depicted in the FIG. 1.

It is also well to note that a resource availability, at 170, 175, etc. may also be depicted as infrastructure availability, such as specific private cloud infrastructure (e.g., VMware® ESX), public clouds such as EC2, etc. Such a collection capably provides for the utilization of computing and storage resources across traditional data centers, virtual data centers, hybrid clouds, private clubs, and/or public clouds.

Also note that the techniques discussed herein provide for identity being utilized at each of the collection locations. For example, hypervisors within 170 may have an associated identity so that constraints can be more effectively applied, resources, at 150, may also have an associated identity so that the resources can be more appropriately assigned, etc.

In an embodiment, the restrictions at 123, 124, 132, and 133 may also specify the use of chargeback credits that have been accumulated as a result of other departments and or business units utilizing the resources of the affected department and/or business unit. This is in lieu of actual money trading hands.

Thus, given a timeline (or resource plan) different resource constraints can be specified for segments of the timeline, such that each of the resource constraints specify a plan that the resource planner wants to use based upon the position on the timeline.

In an embodiment, the resource plan also has a specified resource utilization metric and constraints associated with those metrics such that, as resources are utilized, they are measured—as the resource utilization increases or decreases different resource plans can be activated thereby allowing the resource planner to account for situations where higher than normal resource utilization is required and/or lower than normal resource utilization is to be handled. Accordingly, load-balancing and load-shedding can be accounted for various embodiments presented herein.

In an embodiment, the constraints specified by the resource planner are monitored for modification by external mechanisms. For example, if certain identities are used to specify rights, privileges, roles, etc. and those identities are changed then the constraints reliant upon those identities must be reevaluated. In this case, different notification messages may be sent, along with notifications in the administrator tool, which alert the resource planner to the change. It may be also that the resource planner places a constraint upon certain portions of a resource plan, such that if certain constraints are changed and or the result and impacts of the changes of a certain resource constraint are realized (e.g., cost goes up beyond, say, 10%) that the resource plan can be suspended, the resource planner alerted, and/or no further action taken until the resource plan is again released for production.

In an embodiment, resource plans are made available to a workflow mechanism where other administrators are required to evaluate the resource plan and approve it for utilization. Different administrators may be authorized only to approve the resource plan for utilization within certain areas of the resource pool. Thus, constraints can be specified by the resource planner that, if an administrator does not approve, a certain portion of the plan is put on hold until the resource planner can review the plan in light of the denial of resource access by the associated administrator.

In an embodiment, multiple resource planners may work on different aspects of an aggregate resource plan and the aggregate resource plan pulled together on the timeline, where the resource plans may be added together, stacked side-by-side, etc. to care for different temporal segments on the timeline, and/or activated/deactivated as a result of constraints so that, for example, one resource planner may be taking care of the resource plan for resources to be utilized when resources are being used in excess of normal and another administrator when resources are less than normal, etc.

It is also well to note that the techniques provided herein are not restricted to a single network or cloud, but rather may be interoperable between many different networks and/or many different clouds.

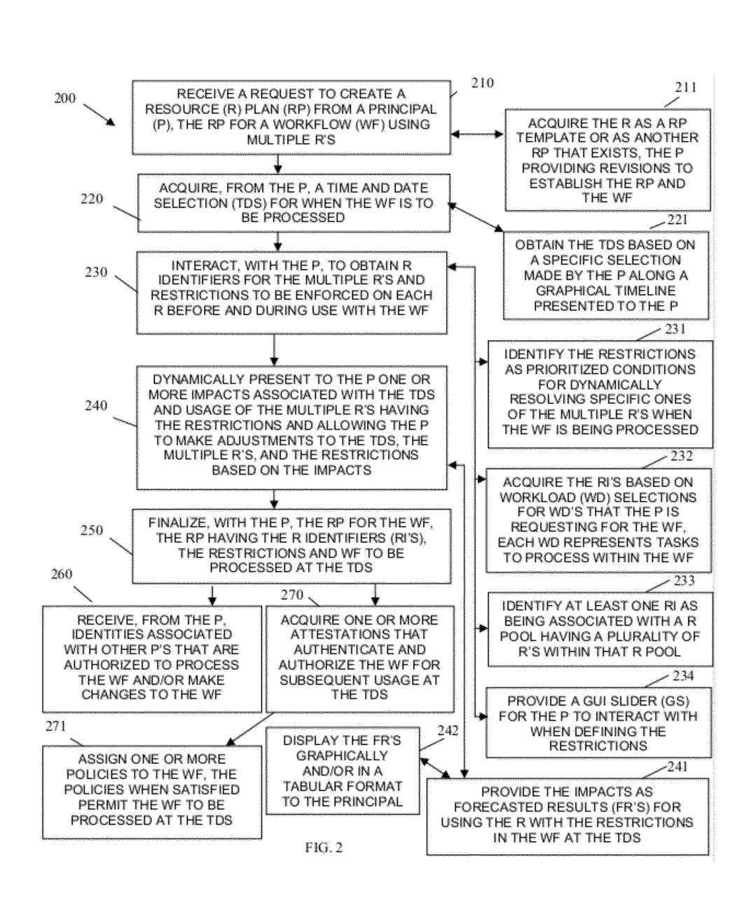

FIG. 2 is a diagram of a method for multi-condition resource planning and management, according to an example embodiment. The method 200 (hereinafter “cloud planning/managing service”) is implemented in a machine-accessible and non-transitory computer-readable medium as instructions that execute on one or more processors (machines, computers, processors, etc.). The machine is specifically configured and programmed to process the cloud planning/managing service. Furthermore, the cloud planning/managing service is operational over and processes within one or more networks. The network(s) may be wired, wireless, or a combination of wired and wireless.

At 210, the cloud planning/managing service receives a request to create a resource plan for a workflow using multiple resources. The workflow includes multiple workloads (processing tasks) that utilize the multiple resources. The request initiates an interactive processing in which the principal works with the cloud planning/managing service to create a resource plan. When the resource plan is complete, the workflow is established.

According to an embodiment, at 211, the cloud planning/managing service acquires the resource as a resource plan template or as another resource plan that already exists. The principal works with the cloud planning/managing service to provide revisions to the template and/or existing resource plan for purposes of establishing the workflow.

At 220, the cloud planning/managing service acquires from the principal a time and date selection for when the workflow is to be processed. It is noted that the time and date selection can be recurring, such as every Wednesday; every 15^{th} of the month; every other week; etc. It may also be that just a time of day is provided and the date can be any available calendar date or vice versa.

In a scenario, at 221, the cloud planning/managing service obtains the time and date selection based on a selection made by the principal along a graphical timeline presented to the principal. This was discussed and shown above with reference to the FIG. 1 where the timeline graphic is shown as item referred to by arrow 210.

At 230, the cloud planning/managing service interacts with the principal to obtain resource identifiers for the multiple resources and restrictions to be enforced on each resource before and during use with the workflow. Different types of constraints and restrictions were discussed in detail above with reference to the discussion of the FIG. 1.

According to an embodiment, at 231, the cloud planning/managing service identifies the restrictions as prioritized conditions for dynamically resolving specific ones of the multiple resources when the workflow is being processed. That is, the conditions can be arranged in priority order or in a hierarchical fashion.

In another case, at 232, the cloud planning/managing service acquires the resource identifiers based on workload selections that the principal is requesting for the workflow. Again, each workload represents tasks that are to be processed within the workflow.

In still another situation, at 233, the cloud planning/managing service identifies at least one resource identifier as being associated with a resource pool. The resource pool having a plurality of resources within that resource pool. In other words, a resource identifier for a single resource can actually reference a pool of resources. So, a resource can be a grouping of resources.

In yet another scenario, at 234, the cloud planning/managing service provides a graphical user interface (GUI) slider bar for the principal to interact with when defining the restrictions. This was presented and described above with reference to the discussion of the FIG. 1. Here, as the principal moves the graphical slider in one direction the restrictions are increased and as the principal moves the graphical slider in an opposite direction the restrictions are decreased. There may be a global slider that controls other sliders as well, such as what was presented and discussed above with reference to the discussion of the FIG. 1. Moreover, each pool of resource constraints or restrictions may have their own slider bar (also shown in the FIG. 1, above).

At 240, the cloud planning/managing service dynamically presents to the principal one or more impacts associated with the time and date selection and usage of the multiple resources having the restrictions. This allows the principal to make interactive adjustments with the cloud planning/managing service to the time and date selection, the multiple resources, and/or the restrictions based on the presented impacts. A description of the impacts was presented above with reference to the FIG. 1. For example, some impacts may include costs associated with using a particular resource so that the principal can visually see what particular selections being made in the resource plan have on things of interest to the principal.

In an embodiment, at 241, the cloud planning/managing service provides the impacts as forecasted results for using the resource with the restrictions in the workflow at the time and date selection. In other words, the cloud planning/managing service assumes that the workflow will process at the designated time with the selections made and based on that forecasts the impacts that are presented to the principal.

Continuing with the embodiment at 241 and at 242, the cloud planning/managing service displays the forecasted results graphically and/or in a tabular format, such as a spreadsheet, database table, and the like.

Finally, at 250, the cloud planning/managing service finalizes, with the principal, the resource plan for the workflow. The resource plan has the resource identifiers and the restrictions and establishes the workflow. The workflow is then scheduled to be processed at the time and date selection finalized by the principal with the cloud planning/managing service.

According to an embodiment, at 260, the cloud planning/managing service receives, from the principal, identities associated with other principals that are designated as authorized by the principal to process the workflow and/or make changes to the workflow.

In another case, at 270, the cloud planning/managing service acquires one or more attestations that authenticate and authorize the workflow for subsequent usage at the time and date selection.

Continuing with the embodiment of 270 and at 271, the cloud planning/managing service assigns one or more policies to the workflow. The policies when satisfied permit the workflow to be processed at the time and date selection.

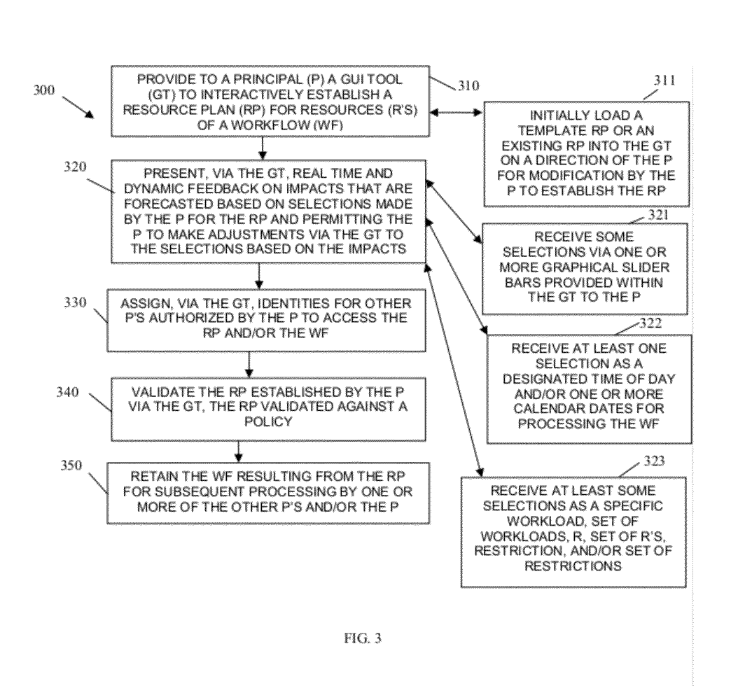

FIG. 3 is a diagram of another method 300 for multi-condition resource planning and management, according to an example embodiment. The method 300 (hereinafter “resource planning/managing service”) is implemented in a machine-accessible and non-transitory computer-readable medium as instructions that execute on one or more processors (machines, computers, processors, etc.). The machine is specifically configured and programmed to process the resource planning/managing service. Furthermore, the resource planning/managing service is operational over and processes within one or more networks. The network(s) may be wired, wireless, or a combination of wired and wireless.

The resource planning/managing service presents another and in some ways enhanced perspective of the cloud planning/managing service represented by the method 200 of the FIG. 2.

At 310, the resource planning/managing service provides to the principal a GUI tool to interactively establish a resource plan for resources of a workflow. Again, once the resource plan is established the workflow is defined.

According to an embodiment, at 311, the resource planning/managing service initially loads a template for the resource plan or an existing resource plan into the graphical tool (GUI tool) on direction provided by the principal for modification by the principal to establish the resource plan. So, the principal need not establish the resource plan from scratch (although in some embodiments the resource plan can be established from scratch).

At 320, the resource planning/managing service presents, via the graphical tool, real time and dynamic feedback on impacts that are forecasted based on selections made by the principal for the resource plan. The resource planning/managing service, via the graphical tool, then allows or permits the principal to make adjustments to the selections based on the principal's assessment of the forecasted impacts.

In an embodiment, at 321, the resource planning/managing service receives some selections via one or more graphical slider bars provided within the graphical tool to the principal. The interaction and description of this situation was presented in detail above with reference to the discussion of the FIG. 1.

In another situation, at 322, the resource planning/managing service receives at least one selection as a designated time of date and/or one or more calendar dates for processing the workflow. So, some of the selections provide for a desired scheduling that the workflow is to be processed.

In yet another case, at 323, the resource planning/managing service receives at least some selections as a specific workload, set of workloads, resource, set of resources, restriction, and/or set of restrictions. The restrictions placed on the resources and/or workloads.

At 330, the resource planning/managing service assigns, via the graphical tool, identities for other principals authorized by the principal to access the resource plan and/or the resulting workflow.

At 340, the resource planning/managing service validates the resource plan established interactively by the principal, via the graphical tool. The resource plan is validated against one or more policies.

At 350, the resource planning/managing service retains the workflow resulting from the resource plan for subsequent processing and/or modification by one or more of the other principals and/or the principal.

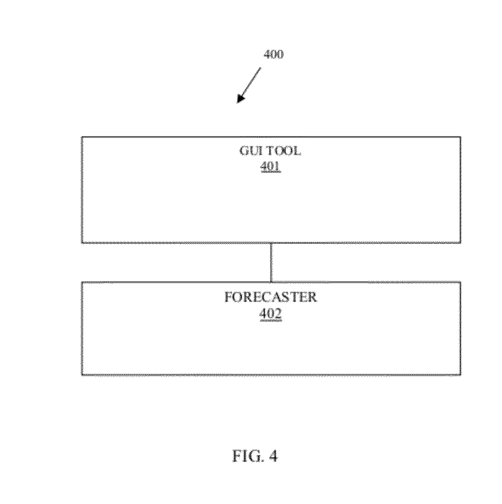

FIG. 4 is a diagram of a multi-condition resource planning and managing system 400, according to an example embodiment. The multi-condition resource planning and managing system 400 is implemented in a machine-accessible and non-transitory computer-readable medium as instructions that execute on multiple processors (machines, computers, processors, etc.). The machines are specifically configured and programmed to process the multi-condition resource planning and managing system 400. Furthermore, the multi-condition resource planning and managing system 400 is operational over and processes within one or more networks. The network(s) may be wired, wireless, or a combination of wired and wireless.

In an embodiment, the multi-condition resource planning and managing system 400 implements, inter alia, the methods 200 and 300 of the FIGS. 2 and 3, respectively, and various aspects of the system and components described in the FIG. 1 above.

The multi-condition resource planning and managing system 400 includes a GUI tool 401 and a forecaster 402. Each of these components and their interactions with one another will now be described below in turn.

The GUI tool 401 is implemented, programmed, and resides within a non-transitory computer-readable storage medium for processing on one or more processors. The processors are configured to execute the GUI tool 401. Example aspects of the GUI tool 401 were provided in detail above with reference to the FIGS. 1-3.

The forecaster 402 is implemented, programmed, and resides within a non-transitory computer-readable storage medium for processing on one or more processors. The processors are configured to execute the forecaster 402. Example aspects of the forecaster 402 were provided in detail above with reference to the FIGS. 1-3.

The GUI tool 401 is configured to interact with a principal for defining a resource plan for a workflow. Moreover, the GUI tool 401 is also configured to interact with the forecaster 402 and the forecaster is configured for dynamically presenting impacts of selections made by the principal when defining the resource plan, via the GUI tool 401.

According to an embodiment, the GUI tool 401 includes one or more graphical slider bars for assisting the principal in defining restrictions for resources defined in the resource plan.

In another case, the GUI tool 401 is also configured to assign identities for other principals for access to the workflow or designated portions of the workflow.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method implemented in a non-transitory machine-readable storage medium and processed by one or more processors configured and programmed to perform the method, comprising:
receiving a request to create a resource plan from a principal, the resource plan for a workflow using multiple resources;
acquiring, from the principal, a time and date selection for when the workflow is to be processed;
interacting, with the principal, to obtain resource identifiers for the multiple resources and restrictions to be enforced on each resource before and during use with the workflow;
dynamically presenting to the principal one or more impacts associated with the time and date selection and usage of the multiple resources having the restrictions and allowing the principal to make adjustments to the time and date selection, the multiple resources, and the restrictions based on the impacts; and
finalizing, with the principal, the resource plan for the workflow, the resource plan having the resource identifiers, the restrictions and the workflow to be processed at the time and date selection.

2. The method of claim 1 further comprising, receiving, from the principal, identities associated with other principals that are authorized to process the workflow and/or make changes to the workflow.

3. The method of claim 1 further comprising, acquiring one or more attestations that authenticate and authorize the workflow for subsequent usage at the time and date selection.

4. The method of claim 3 further comprising, assigning one or more policies to the workflow, the policies when satisfied permit the workflow to be processed at the time and date selection.

5. The method of claim 1, wherein receiving further includes acquiring the request as a resource plan template or as another resource plan that exists, the principal providing revisions to establish the resource plan and the workflow.

6. The method of claim 1, wherein acquiring further includes obtaining the time and date selection based on a specific selection made by the principal along a graphical timeline presented to the principal.

7. The method of claim 1, wherein interacting further includes identifying the restrictions as prioritized conditions for dynamically resolving specific ones of the multiple resources when the workflow is being processed.

8. The method of claim 1, wherein interacting further includes acquiring the resource identifiers based on workload selections for workloads that the principal is requesting for the workflow, each workload representing one or more tasks to process within the workflow.

9. The method of claim 1, wherein interacting further includes identifying at least one resource identifier as being associated with a resource pool having a plurality of resources within that resource pool.

10. The method of claim 1, wherein interacting further includes providing a graphical slider for the principal to interact with when defining the restrictions, as the principal moves the graphical slider in one direction the restrictions are increased and as the principal moves the graphical slider in an opposite direction the restrictions are decreased.

11. The method of claim 1, wherein dynamically presenting further includes providing the impacts as forecasted results associated with using the resource with the restrictions in the workflow at the time and date selection.

12. The method of claim 11, wherein providing further includes displaying the forecasted results graphically and/or in a tabular format to the principal.

13. A method implemented in a non-transitory machine-readable storage medium and processed by one or more processors configured and programmed to perform the method, comprising:
providing to a principal a graphical user interface (GUI) tool for interactively establishing a resource plan for resources of a workflow;
presenting, via the GUI tool, real time and dynamic feedback on impacts that are forecasted based on selections made by the principal for the resource plan and permitting the principal to make adjustments via the GUI tool to the selections based on the impacts;
assigning, via the GUI tool, identities for other principals authorized by the principal to access the resource plan and/or the workflow;
validating the resource plan established by the principal via the GUI tool, the resource plan validated against a policy; and
retaining the workflow resulting from the resource plan for subsequent processing by one or more of the other principals and/or the principal.

14. The method of claim 13, wherein providing further includes initially loading a template resource plan or an existing resource plan into the GUI tool on a direction of the principal for modification by the principal to establish the resource plan.

15. The method of claim 13, wherein presenting further includes receiving some selections via one or more graphical slider bars provided within the GUI tool to the principal.

16. The method of claim 13, wherein presenting further includes receiving at least one selection as a designated time of day and/or one or more calendar dates for processing the workflow.

17. The method of claim 13, wherein presenting further includes receiving at least some selections as a specific workload, set of workloads, resource, set of resources, restriction, and/or set of restrictions.

18. A multi-processor implemented system, comprising:
a graphical user interface (GUI) tool configured to execute on one or more processors; and
a forecaster configured to execute on one or more of the processors;
the GUI tool is configured to interact with a principal to define a resource plan for a workflow, the GUI tool is also configured to interact with the forecaster, the forecaster configured to dynamically present impacts of selections made by the principal when defining the resource plan via the GUI tool.

19. The system of claim 18, wherein the GUI tool includes one or more graphical slider bars for assisting the principal in defining restrictions for resources defined in the resource plan.

20. The system of claim 18, wherein the GUI tool is configured to assign identities for other principals for access to the workflow or portions of the workflow.
